(19) United States
(12) Patent Application Publication
(10) Pub. No.: US 2008/0097982 A1
(43) Pub. Date: Apr. 24, 2008

(54) System and method for classifying search queries

(75) Inventor: Abhinav Gupta, Sunnyvale, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc.

(21) Appl. No.: 11/583,495

(22) Filed: Oct. 18, 2006

(51) Int. Cl. G06F 17/30

(52) U.S. Cl. 707/5

(57) ABSTRACT

A system and method for categorizing search queries is disclosed. Generally, a search query is received. A categorizer determines whether a probability of the search query being in a taxonomy category is greater than a probability of the search query not being in the taxonomy category. If the probability that the search query being in the taxonomy category is greater than the probability of the search query not being in the taxonomy category, the categorizer determines a confidence score based on the two probabilities. The categorizer then compares the confidence score to the confidence score threshold of the taxonomy category to determine whether the search query should be categorized in the taxonomy category.

### BACKGROUND

Advertisers who advertise with online advertisement providers (“ad providers”) such as Yahoo! Search Marketing often target advertisements to potential customers based on historical data of the ad provider evidencing relationships between search terms in search queries submitted by users, or webpage content in webpages visited by users, and interests displayed by those same users. However, a first user who submits a search query or visits a webpage may have different interests than a second user who submits the same search query or visits the same webpage. Therefore, advertisements targeted to potential customers based on displayed interests of the first user may not accurately apply to potential customers with interests similar to the second user. For this reason, it would be desirable to have a system and method that categorizes the interests of specific users so that advertisers can more accurately target ads to known, displayed interests of specific users.

### BRIEF DESCRIPTION OF THE DRAWINGS

FIG. 1 is a block diagram of one embodiment of an environment in which a system for classifying search queries into taxonomy categories may operate;

FIG. 2 is a block diagram of one embodiment of a system for classifying search queries into taxonomy categories; and

FIG. 3 is a flow chart of one embodiment of a method for classifying search queries into taxonomy categories.

### DETAILED DESCRIPTION OF THE DRAWINGS

The present disclosure relates to a system and method for classifying search queries. Classifying search queries allows an ad provider to classify the interests of specific users so that advertisers may more accurately target ads to known interests of specific users. Targeting ads to known interests of specific users provides advertisers increased confidence that ad providers are serving their ads to users who have actually displayed an interest in an area of a taxonomy category.

Classifying search queries may additionally provide the ability to use specialized search engines. For example, if a search query is categorized as a music search, the search engine may supply search results obtained from a music search engine that specializes in search results relating to music rather than providing search results from a standard search engine. Classifying search queries additionally provides for improved internal reporting due to the fact ad providers may create reports detailing which topics (query categories) are most searched by users.

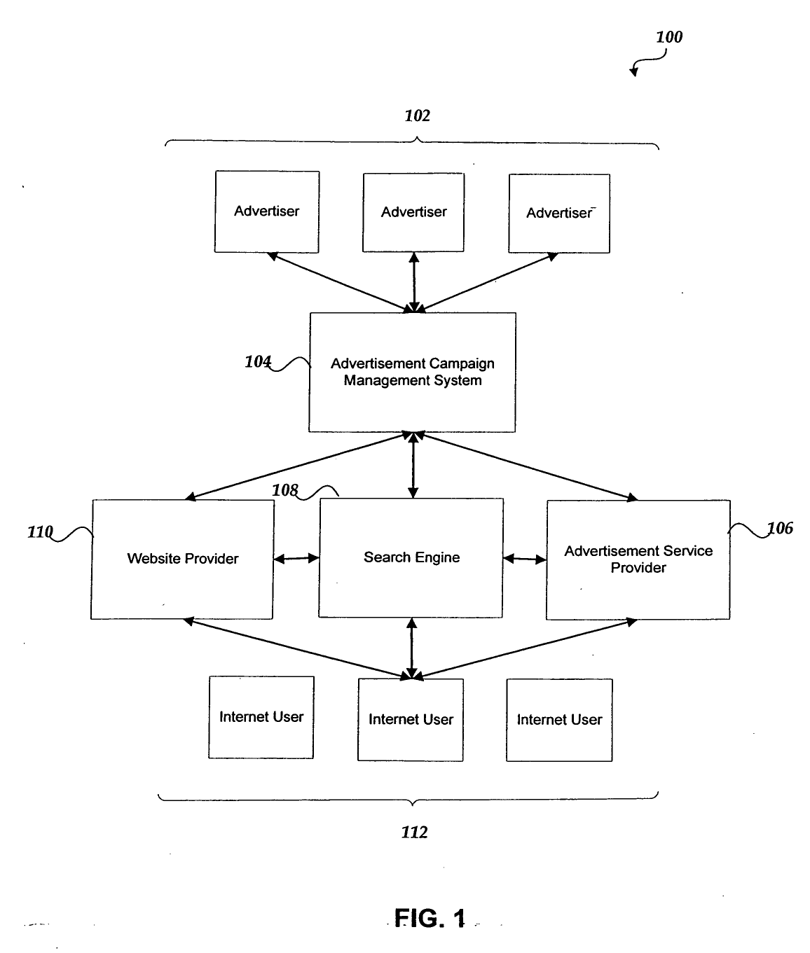

FIG. 1 is a block diagram of one embodiment of an environment in which the disclosed system and method for classifying search queries may operate. The environment 100 includes a plurality of advertisers 102, an advertisement campaign management system 104, an advertisement service provider 106, a search engine 108, a website provider 110, and a plurality of Internet users 112. Generally, an advertiser 102 creates an advertisement by interacting with the advertisement campaign management system 104. The advertisement may be a banner advertisement that appears on a website viewed by Internet users 112, an advertisement that is served to an Internet user 108 in response to a search performed at a search engine, or any other type of online advertisement known in the art.

When an Internet user 112 performs a search at a search engine 106, or views a website served by the website provider 108, the advertisement service provider 106 serves one or more advertisements created using the advertisement campaign management system 104 to the Internet user 112 based on search terms or keywords provided by the internet user or obtained from a website. Additionally, the advertisement campaign management system 104 and advertisement service provider 106 typically record and process information associated with the served advertisement. For example, the advertisement campaign management system 104 and advertisement service provider 106 may record the search terms that caused the advertisement service provider 106 to serve the advertisement; whether the Internet user 112 clicked on a URL associated with the served advertisement; what additional advertisements the advertisement service provider 106 served with the advertisement; a rank or position of an advertisement when the Internet user 112 clicked on an advertisement; or whether an Internet user 112 clicked on a URL associated with a different advertisement. It will be appreciated that the below-described system and method for classifying search queries may operate in the environment of described with respect to FIG. 1.

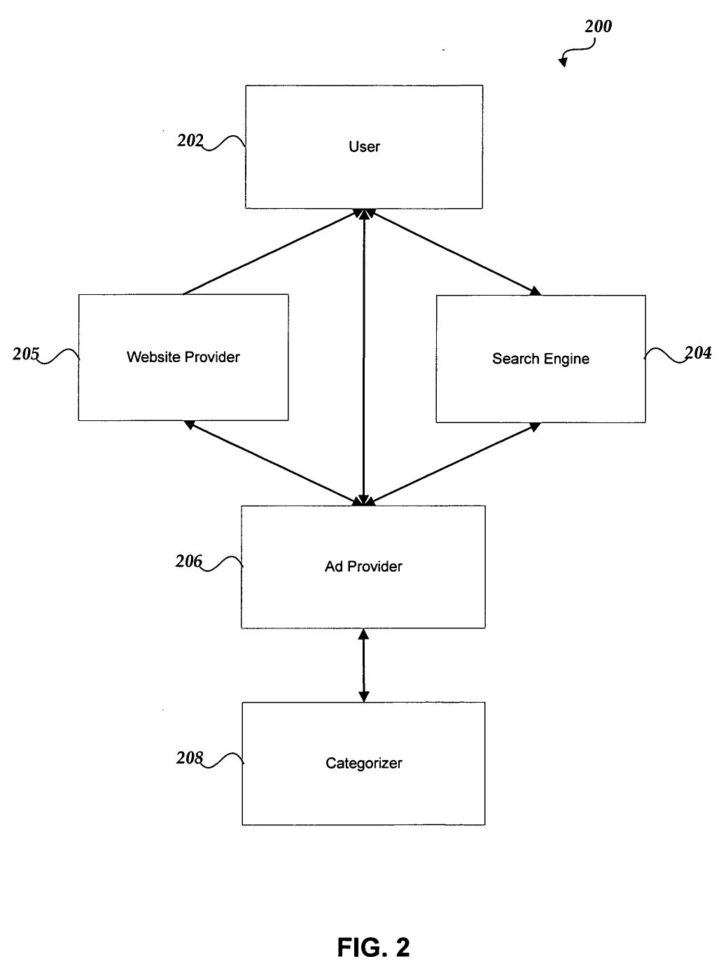

FIG. 2 is a block diagram of one embodiment of a system for classifying search queries into taxonomy categories. Generally, the system 200 includes one or more Internet user systems 202, a search engine 204, a website provider 205, an ad provider system 206, and a categorizer 208. Typically, the Internet user systems 202 are able to communicate with at least the search engine 204 and the website provider 205 over a network such as the Internet, and the search engine 204, website provider 205, ad provider 206, and categorizer 208 are able to communicate with each other over external or internal networks. The Internet user systems 202, search engine 204, website provider 205, ad provider system 206, and categorizer 208 may be implemented as software code running in conjunction with a processor such as a personal computer, a single server, a plurality of servers, or any other type of computing device known in the art.

Before classifying search queries based on search terms received at the search engine 204 or from a webpage served by the website provider 205 as described above, the ad provider 206 and/or categorizer 208 creates a search term database. Typically, reviewers employed by the ad provider 206 and/or the categorizer 208 manually review each of a plurality of training search queries and classify the training search queries into one or more taxonomy categories. A taxonomy category is a category representing an area of interest of a user such as Automotive, Automotive/Alternative Fuel Vehicles, Automotive/Convertible, Consumer Packaged Goods, Entertainment, Small Sales Business, Technology, Travel, or any other taxonomy category desired. In some implementations, taxonomy categories may be structured in a tree hierarchy. For example in the illustrative examples of taxonomy categories above, Automotive/Alternative Fuel Vehicles and Automotive/Convertible are both related as child taxonomy categories to the parent taxonomy category of Automotive. It will be appreciated that the above-described tree structure may continue for any number of levels.

Typically, training queries are classified into the deepest taxonomy category possible in the tree hierarchy of the taxonomy categories. The ad provider 206 and/or categorizer 208 may then perform an operation to populate each taxonomy category with any training queries in the one or more levels below that taxonomy category (any descendant taxonomy categories). Continuing with the example above, if one or more training search queries are categorized in the Automotive/Alternative Fuel Vehicle taxonomy category, the ad provider 206 and/or categorizer 208 will perform an operation to populate the higher-level Automotive taxonomy category with the one or more training search queries classified in the Automotive/Alternative Fuel Vehicle taxonomy category.

It should also be noted that a training query may be classified into more than one taxonomy category. For example, the search query “healthcare administration candidates” may be classified into the taxonomy categories “Small Business”, and “Corporate Services/Human Resources/Healthcare Recruiters”. Similarly, the search query “preowned Suzuki aerio” may be classified into the taxonomy categories of Automotive/Price/Economy; Automotive/Sedan; and Automotive/Used.

After the training search queries are classified into one or more taxonomy categories and each taxonomy category is populated with the training search queries of any descendant taxonomy categories in the tree hierarchy, the ad provider 206 and/or categorizer 208 determine a number of times a search term appears in each taxonomy category of the search term database and a number of times a search term appears in all taxonomy categories of the search term database.

For example, for the term “preowned,” the ad provider 206 and/or categorizer 208 may determine the term appears in all taxonomy categories 1500 times and that the term appears in the taxonomy categories related to Automotive 1200 times. Similarly, the ad provider 206 and/or categorizer 208 may determine the term “Toyota” appears in all categories 2000 times and appears in taxonomy categories related to Automotive 1800 times.

After the search term database is created, the user 202 may submit a search query to a search engine 204 or the ad provider 206 may receive a search query from a website provider 205. The search query may include one or more search terms and each search term may include one or more words. The search engine 204 or website provider 205 sends the search query to the ad provider 206 and requests one or more ads such as graphical ads to insert into a webpage or sponsored search listings to include in search results. It will be appreciated that the search engine 204, the website provider 205, and the ad provider 206 may be operated by the same or different entities. The ad provider 206 may return one or more ads to the search engine 204 or website provider 205 to serve to the user 202, or the ad provider 206 may serve the ads directly to the user 202. The categorizer 208 is in communication with the ad provider 206 and examines the received search query to classify the search query of the user into one or more taxonomy categories. The ad provider 206 may then use the taxonomy category classifications to classify the interests of the specific user submitting the request. One example of a system and method for classifying the interests of a user based on classified user events is disclosed in U.S. patent application Ser. No. 11/394,342, filed Mar. 29, 2006.

Classifying the interests of specific users allows the search engine 204, website provider 205, and/or ad provider 206 to target relevant ads, personalize content, or suggest webpages to a user based on the known interests of the user. To categorize the search query into one or more of the taxonomy categories, for each taxonomy category in the search term database, the categorizer 208 determines the probability that the search query is in the taxonomy category and the probability that the search query is not in the taxonomy category. When the probability that the search query is in the taxonomy category is greater than the probability that the search query is not in the taxonomy category, the categorizer 208 determines a confidence score based on the two probabilities. The categorizer 208 then determines whether to classify the search query as being in the taxonomy category based on the confidence score and a confidence score threshold of the taxonomy category. Each taxonomy category may have a different confidence score threshold for a search query to be placed in the taxonomy category. For example, a first taxonomy category such as Telecommunications may require a large confidence score to classify the search query in the taxonomy category where a second category such as Automotive may require a low confidence score to classify the search query in the taxonomy category.

The categorizer 208 may determine the probability that a search query is in a taxonomy category based on the probability that each search term in the search query is in the taxonomy category. For example if a search query includes a first term, a second term, and a third term, the categorizer 208 determines a first probability that the first term is in the taxonomy category, a second probability that the second term is in the taxonomy category, and a third probability that the third term is in the taxonomy category. The categorizer 208 then determines the product of the first, second, and third probabilities to determine the probability that the search query is in the taxonomy category.

In one implementation, the categorizer 208 determines the probability that a search term is in a taxonomy category by dividing a number of times a search term appears in a taxonomy category in the search term database by a number of times the search term appears in all taxonomy categories in the search term database.

The categorizer 208 may additionally weight the probability of a search term being in a taxonomy category based on a frequency of how often each search term of the search query appears in a specific taxonomy category in the search term database and how often the search term appears in all taxonomy categories in the search term database. The probabilities may be weighted based on frequency due to the fact that some search terms may be rare in search queries when compared to more common search terms. Therefore, the categorizer 208 should be influenced more by search terms that appear frequently in the search term database than search terms that appear infrequently in the search term database.

As with the probability that a search query is in a taxonomy category, the categorizer 208 may determine the probability that a search query is not in a taxonomy category based on the probability that each search term in the search query is not in the taxonomy category. Continuing with the example above where a search query includes a first term, a second term, and a third term, the categorizer 208 determines a first probability that the first term is not in the taxonomy category, a second probability that the second term is not in the taxonomy category, and a third probability that the third term is not in the taxonomy category. The categorizer 208 then determines the product of the first, second, and third probability to determine the probability that the search query is not in the taxonomy category. As described above, the probability that a search query is not in a taxonomy category may be weighted based on the frequency of how often each search term in the search query appears in a specific taxonomy category in the search term database and how often the search term appears in all taxonomy categories in the search term database.

In one implementation, the categorizer 208 determines the probability that a search term is not in a taxonomy category by dividing the number of times a search term appears in all other taxonomy categories in the search term database by the number of times the search term appears in all taxonomy categories in the search term database.

After determining the probability that the search query is in a taxonomy category and the probability that the search query is not in a taxonomy category, the categorizer 208 compares the two probabilities. If the probability that the search query is not in the taxonomy category is greater than the probability that the search query is in the taxonomy category, the categorizer 208 determines the search query is not in the taxonomy category. However, if the probability that the search query is in the taxonomy category is greater than the probability that the search query is not in the taxonomy category, the categorizer 208 determines a confidence score. In one implementation, the categorizer 208 calculates a confidence score by taking a logarithm of the quantity the probability that the search term is in a taxonomy category divided by the probability that the search query is not in the taxonomy category.

Based on the confidence score, the categorizer 208 determines whether to classify the search query in the taxonomy category based on the confidence score threshold necessary to classify a search query in the taxonomy category. As discussed above, each taxonomy category may require a different confidence score level to classify a search query in the taxonomy category. However, a taxonomy category will typically require a high enough confidence score level to ensure that the probability that a search query is in a taxonomy category is much larger than the probability that the search query is not in the taxonomy category. In some implementations the confidence score threshold of a taxonomy category may be set manually, but in other implementations, adjustment of a confidence score threshold of a taxonomy category may be automated as a function of known values such as training search queries and known taxonomy classifications of the training search queries.

The categorizer 208 repeats the above-described process for each taxonomy category of the ad provider 206 and classifies the search query as being in any of taxonomy categories where the search query has the appropriate confidence score described above. However, it is possible for a search query not to be classified as being in any of the taxonomy categories.

In addition to breaking a search query into one or more search terms, the categorizer 208 may additionally examine the sequence of words of the search query to determine if the sequence of any terms constitute an additional search term. For example, if a search query is “George Bush Speeches,” the categorizer 208 may break the search query into the search terms George, Bush, and Speeches. Additionally, the categorizer 208 will determine an additional search term of “George Bush” from the search query. Therefore, the categorizer 208 will determine a probability of the search query being in each taxonomy category and a probability of the search query not being in each taxonomy category based on the search terms George, Bush, Speeches, and George Bush. Typically, the categorizer 208 may determine if the search query contains additional terms by comparing the search query to a list of known compound terms. The list of known compound terms may be compiled based on the detection of words that co-occur frequently in logged search queries; known compound terms such as the names of people, places, or company names; or any other source of compound terms.

Users may sometimes submit search queries with new words that did not appear in the training search queries described above. Using the example above, a user may submit a search query “George Bush X,” where X is an imaginary or new word. Due to the fact the search term X is new and the probability of the search term X being in each taxonomy category would likely be zero, the probability of the search query being in each of the taxonomy categories would also be zero even though the word X is likely related to a taxonomy category regarding politics. In order to address this problem, the categorizer 108 may assign a low probability to each new search term that does not appear in the training search queries so that the probability of the search query being in each taxonomy category is not zero. Alternatively, to address the problem, the categorizer 208 may assign a probability to the new search term of a probability associated with a second term when the categorizer 208 determines the new search term is related to the second term appearing in the training search queries. In some implementations, the categorizer 208 may determine a new search term is related to a second search term based on similarities between the new search term and the second search term based on a context of the search query or when the new search term and the second search term normally appear next to the same search term in a search query. For example, to determine if the term football is related to baseball, the categorizer 208 may examine how often terms such as football schedule and baseball schedule; football players and baseball players; and football scores and baseball scores occur in the search logs of the search engine 204 and/or ad provider 206.

Often, the probability that a search query is not in a taxonomy category is much larger than the probability that a search query is in the taxonomy category. Therefore, rather than store all combinations of search terms that are not in a taxonomy category, the ad provider 206 and/or ad categorizer 208 may store a number of times a search term occurs in a taxonomy category and a number of times the search term occurs in all taxonomy categories so that the ad categorizer 208 may derive a number of times the search term occurs outside of each taxonomy category. Storing one large dense column of data and a large sparse table (many sparse columns) typically requires less memory than storing many dense columns of data. By storing many sparse columns of data when storing a number of times a search term occurs in a taxonomy category and a number of times the search term occurs in all taxonomy categories, the ad categorizer 208 reduces the chances of overflowing an amount of random access memory (RAM) on the servers on which the ad provider 206 and/or ad categorizer 208 are located.

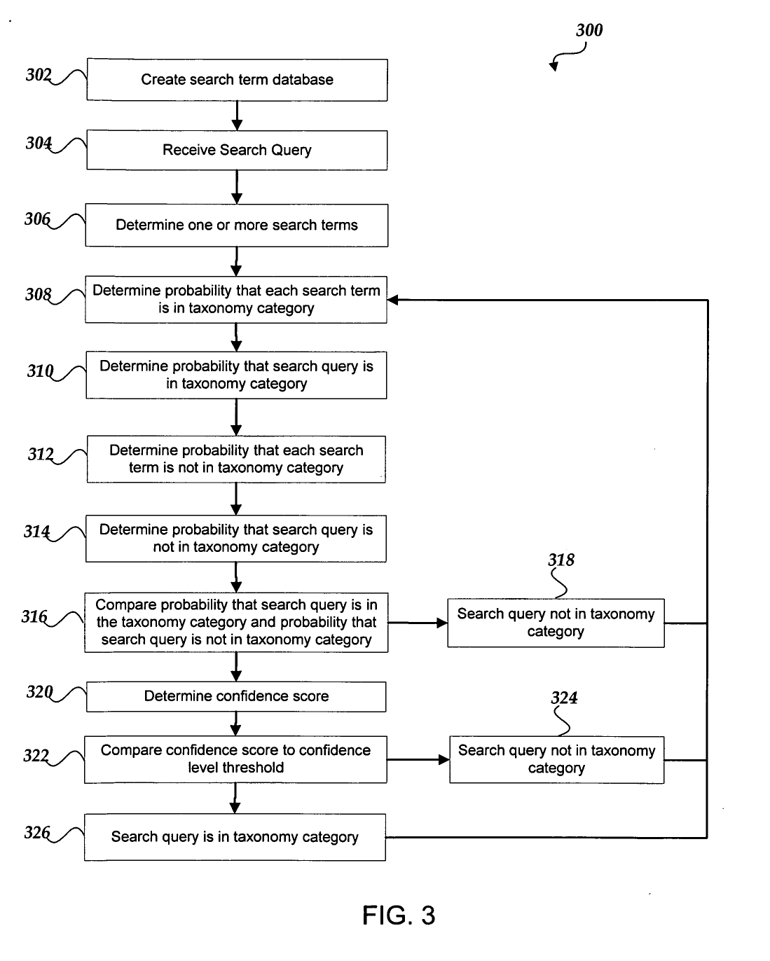

FIG. 3 is a flow chart of one embodiment of a method for classifying search queries into taxonomy categories. The method 300 begins with the creation of a search term database at step 302. As described above, one or more training search queries are (manually) classified into one or more taxonomy categories so that later search queries may use the search term database to determine whether the search query should be classified as being in, or not being in, each taxonomy category.

The ad provider receives a search query at step 304. The categorizer accesses the search query and determines one or more search terms based on the search query at step 306. As discussed above, each search term may include one or more words. The categorizer determines the probability of each search term of the search query being in a taxonomy category at step 308 and multiplies the probability that each search term is in the taxonomy category to determine the probability that the search query is in the taxonomy category at step 310.

The categorizer determines the probability of each search term of the search query not being in the taxonomy category at step 312 and multiplies the probability that each search term is not in the taxonomy category to determine the probability that the search query is not in the taxonomy category at step 314.

The categorizer compares the determined probability that the search query is in the taxonomy category to the probability that the search query is not in the taxonomy category at step 316. If the categorizer determines that that the probability of the search query not being in the taxonomy category is greater than the probability of the search query being in the taxonomy category, the categorizer determines the search query is not in the taxonomy category at step 318 and the process loops to step 308 to repeat the above-described method for each taxonomy category at the ad provider.

If the categorizer determines that the probability of the search query being in the taxonomy category is greater than the probability of the search query not being in the taxonomy category, the categorizer determines a confidence score based on the two probabilities at step 320. The categorizer compares the determined confidence score to a confidence level threshold of the taxonomy category at step 322. If the categorizer determines the determined confidence score does not meet the confidence level threshold, the categorizer determines the search query is not in the taxonomy category at step 324 and the process loops to step 308 to repeat the above-described method for each taxonomy category at the ad provider. If the categorizer determines the determined confidence score meets the confidence level threshold, the categorizer determines the search query is in the taxonomy category at step 326 and the process loops to step 308 to repeat the above-described method for each taxonomy category at the ad provider. The method 300 ends after the categorizer has determined whether or not the search query is in each of the taxonomy categories.

Below is an illustrative example for one implementation of determining whether to classify the search queries “preowned Toyota Camry,” “preowned Toyota Tundra,” and “preowned Toyota potato” into the automotive taxonomy category. Table A below lists the vales associated with the number of times the terms preowned, Toyota, Camry, Tundra, and potato occur in the taxonomy category Automobile and the number of times the same terms occur in all taxonomy categories.

TABLE A
Example Search Term Database Values

| | All | | |
|---|---|---|---|
| Term | Categories | Automotive | Not Automotive |
| Preowned | 1500 | 1200 | 300 |
| Toyota | 2000 | 1800 | 200 |
| Camry | 1000 | 990 | 10 |
| Tundra | 200 | 50 | 150 |
| Potato | 500 | 2 | 498 |

In determining whether to classify the search query “preowned Toyota Camry” into the automotive taxonomy category, the search query is broken into the terms preowned, Toyota, and Camry. As described above, the categorizer determines the probability that each term is in the automotive taxonomy category and the probability that each term is not in the taxonomy category. The probability that the term is in the taxonomy category may be calculated by dividing the number of times that the term occurs in the taxonomy category by the number of times that the term occurs in all taxonomy categories. The probability that the term is not in the taxonomy category may be calculated by dividing the number of times that the term occurs in all other taxonomy categories by the number of times that the term occurs in all taxonomy categories. Table B below lists the probabilities that the terms preowned, Toyota, and Camry are in the automotive category and the probabilities that the same terms are not in the taxonomy category.

TABLE B

| Term | Probability In | Probability Out |
|---|---|---|
| Preowned | 1200/1500 = 0.8 | 300/1500 = 0.2 |
| Toyota | 1800/2000 = 0.9 | 200/2000 = 0.1 |
| Camry | 990/1000 = 0.99 | 10/1000 = 0.01 |

As described above, the probability that the search query “preowned Toyota Camry” is in the automotive taxonomy category may be calculated by taking the product of the probability that each term is in the automotive taxonomy category.

Probability In=0.8*0.9*0.99=0.7128

As described above, the probability that the search query “preowned Toyota Camry” is not in the taxonomy category may be calculated by taking the product of the probability that each term in not in the automotive taxonomy category.

Probability Out=0.2*0.1*0.01=0.0002

The probability that the search query “preowned Toyota Camry” is in the automotive taxonomy category is compared to the probability that the search query is not in the taxonomy category. Due to the fact the probability that the search query is in the taxonomy category is greater than the probability that the search query is not in the taxonomy category, the categorizer calculates a confidence score. As described above, the confidence score may be calculated by taking the logarithm of the quantity the probability that the search query is in the taxonomy category divided by the probability that the search query is not in the search query.

Confidence Score=log(0.7128/0.0002)=3.5

The categorizer compares the calculated confidence score to the confidence score threshold of the automotive taxonomy category. If the automotive taxonomy category has a confidence score threshold of 2.0, the search query “preowned Toyota Camry” is classified in the automotive taxonomy category due to the fact the calculated confidence score exceeds the confidence score threshold.

In determining whether to classify the search query “preowned Toyota Tundra” into the automotive taxonomy category, the search query is broken into the terms preowned, Toyota, and Tundra. As described above, the categorizer determines the probability that each term is in the automotive taxonomy category and the probability that each term is not in the taxonomy category. Table C below lists the probabilities that the terms preowned, Toyota, and Tundra are in the automotive category and the probabilities that the same terms are not in the taxonomy category.

TABLE C

| Term | Probability In | Probability Out |
|---|---|---|
| Preowned | 1200/1500 = 0.8 | 300/1500 = 0.2 |
| Toyota | 1800/2000 = 0.9 | 200/2000 = 0.1 |
| Tundra | 50/200 = 0.25 | 150/200 = 0.75 |

As described above, the probability that the search query “preowned Toyota Tundra” is in the automotive taxonomy category may be calculated by taking the product of the probability that each term is in the automotive taxonomy category.

Probability In=0.8*0.9*0.25=0.18

As described above, the probability that the search query “preowned Toyota Tundra” is not in the taxonomy category may be calculated by taking the product of the probability that each term in not in the automotive taxonomy category.

Probability Out=0.2*0.1*0.75=0.015

The probability that the search query “preowned Toyota Tundra” is in the automotive taxonomy category is compared to the probability that the search query is not in the taxonomy category. Due to the fact the probability that the search query is in the taxonomy category is greater than the probability that the search query is not in the taxonomy category, the categorizer calculates a confidence score. As described above, the confidence score may be calculated by taking the logarithm of the quantity the probability that the search query is in the taxonomy category divided by the probability that the search query is not in the search query.

Confidence Score=log(0.18/0.015)=1.0

The categorizer compares the calculated confidence score to the confidence score threshold of the automotive taxonomy category. If the automotive taxonomy category has a confidence score threshold of 2.0, the search query “preowned Toyota Tundra” is not classified in the automotive taxonomy category due to the fact the calculated confidence score does not exceeds the confidence score threshold.

In determining whether to classify the search query “preowned Toyota potato” into the automotive taxonomy category, the search query is broken into the terms preowned, Toyota, and potato. As described above, the categorizer determines the probability that each term is in the automotive taxonomy category and the probability that each term is not in the taxonomy category. Table D below lists the probabilities that the terms preowned, Toyota, and potato are in the automotive category and the probabilities that the same terms are not in the taxonomy category.

TABLE D

| Term | Probability In | Probability Out |
|---|---|---|
| Preowned | 1200/1500 = 0.8 | 300/1500 = 0.2 |
| Toyota | 1800/2000 = 0.9 | 200/2000 = 0.1 |
| Potato | 2/500 = 0.004 | 498/500 = 0.996 |

As described above, the probability that the search query “preowned Toyota potato” is in the automotive taxonomy category may be calculated by taking the product of the probability that each term is in the automotive taxonomy category.

Probability In=0.8*0.9*0.004=0.00288

As described above, the probability that the search query “preowned Toyota potato” is not in the taxonomy category may be calculated by taking the product of the probability that each term in not in the automotive taxonomy category.

Probability Out=0.2*0.1*0.996=0.01992

The probability that the search query “preowned Toyota potato” is in the automotive taxonomy category is compared to the probability that the search query is not in the taxonomy category. Due to the fact the probability that the search query is in the taxonomy category is less than the probability that the search query is not in the taxonomy category, the categorizer determines the search query “preowned Toyota potato” is not in the automotive taxonomy category.

FIGS. 1-3 describe systems and method for classifying search queries into taxonomy categories. Classifying search queries into taxonomy categories allows an ad provider to determine the interests of specific users submitting the search queries. By determining the interests of specific users, the ad providers and advertisers may target the user with ads in areas the user has actually demonstrated an interest it.

It is therefore intended that the foregoing detailed description be regarded as illustrative rather than limiting, and that it be understood that it is the following claims, including all equivalents, that are intended to define the spirit and scope of this invention.

1. A method for categorizing a search query comprising:
receiving a search query;
determining whether a probability of the search query being in a taxonomy category is greater than a probability of the search query not being in the taxonomy category;
calculating a confidence score based on the probability of the search query being in the taxonomy category and the probability of the search query not being in the taxonomy category in response to determining the probability of the search query being in the taxonomy category is greater than the probability of the search query not being in the taxonomy category; and
comparing the confidence score to a confidence score threshold of the taxonomy category to determine whether the search query should be categorized in the taxonomy category.

2. The method of claim 1, wherein determining whether a probability of the search query being in a taxonomy category is greater than a probability of the search query not being in the taxonomy category comprises:
determining one or more search terms based on the search query;
determining a probability of each of the one or more search terms being in the taxonomy category;
determining a product of the probabilities of the one or more search terms being in the taxonomy category to determine the probability of the search query being in the taxonomy category;
determining a probability of each of the one or more search terms not being in the taxonomy category; and
determining a product of the probabilities of the one or more search terms not being in the taxonomy category to determine the probability of the search query not being in the taxonomy category.

3. The method of claim 2, wherein the probability of a search term being in a taxonomy category is determined based on a number of times the search term appears in the taxonomy category in a search term database and a number of times the search term appears in all taxonomy categories in the search term database.

4. The method of claim 3, wherein the probability of each search term appearing in the taxonomy category is weighted based on a number of times the search term appears in the search term database.

5. The method of claim 2, wherein the probability of a search term not being in a taxonomy category is determined based on a number of times the search term appears on all other taxonomy categories in a search term database and a number of times the search term appears in all taxonomy categories in the search term database.

6. The method of claim 2, further comprising:
determining at least one additional multi-word search term based on a sequence of the one or more search term comprising the search query.

7. The method of claim 2, further comprising:
determining a first search term of the one or more search terms is not in the search term database;
determining a second search term in the search term database is associated with the first search term; and
assigning the probabilities associated with the second term in the search term database to the first term.

8. The method of claim 2, further comprising:
determining a search term of the one or more search terms is not in the search term database; and
assigning a low, non-zero probability to the search term being in each taxonomy category.

9. The method of claim 1, wherein the confidence score is determined by calculating a logarithm of the quantity the probability that the search query is in the taxonomy category divided by the probability that the search query is not in the taxonomy category.

10. The method of claim 1, further comprising:
creating a search term database based on a plurality of training search queries comprising one or more search terms.

11. The method of claim 1, further comprising:
creating a search term database comprising a number of times a search term occurs in a taxonomy category and a number of times the search term occurs in all taxonomy categories.

12. A computer-readable medium comprising a set of instructions for categorizing a search query, the set of instructions to direct a processor to perform acts of:
creating a search term database based on a plurality of training search queries;
receiving a search query;
determining based on the search term database whether the probability of the search query being in a taxonomy category is greater than a probability of the search query not being in the taxonomy category;
calculating a confidence score based on the probability of the search query being in the taxonomy category and the probability of the search query not being in the taxonomy category in response to determining the probability of the search query being in the taxonomy category is greater than the probability of the search query not being in the taxonomy category;
comparing the confidence score to a confidence score threshold of the taxonomy category to determine whether the search query should be categorized in the taxonomy category.

13. A system for categorizing a search query comprising:
a categorizer, in communication with an online advertisement service provider (“ad provider”), to receive a search query comprising one or more search terms from the ad provider, and to determine whether the search query should be categorized into one or more taxonomy categories;
wherein for each taxonomy category, the categorizer determines based on a search term database a first probability that the search query is in the taxonomy category and a second probability that the search query is not in the taxonomy category, and determines whether the search query should be categorized into the taxonomy category based on the first and second probabilities.

14. The system of claim 13, wherein the search term database comprises for each search term in the search database, a number of times a search term occurs in each taxonomy category in the search term database and a number of times the search term occurs in all taxonomy categories in the search term database.

15. The system of claim 13, wherein the categorizer determines the probability that the search query is in each taxonomy category based on one or more search terms that comprise the search query, and a number of times the one or more search terms occur in a taxonomy category and a number of times the one or more search terms occurs in all taxonomy categories.

16. The system of claim 13, wherein the categorizer determines the probability that the search query is not in each taxonomy category based on one or more search terms that comprise the search query, and a number of times the one or more search terms occur in all other taxonomy categories than a taxonomy category and a number of times the one or more search terms occur in all taxonomy categories.

17. The system of claim 13, wherein the first and second probabilities are weighted based on a number of times the one or more search terms that comprise the search query are present in all the taxonomy categories.

18. The system of claim 13, wherein for each taxonomy category, when the first probability is greater than the second probability for a taxonomy category, the categorizer determines whether the search query should be categorized into the taxonomy category based on a confidence score and a confidence score threshold of the taxonomy category.

19. The system of claim 18, wherein the categorizer calculates the confidence score by calculating a logarithm of the quantity the first probability divided by the second probability.

20. The system of claim 13, wherein the categorizer is operative to determine whether the search query comprises a multi-word search term based on a sequence of the search terms that comprise the search query.
